(19) United States
(12) Patent Application Publication
(10) Pub. No.: US 2009/0170678 A1
(43) Pub. Date: Jul. 2, 2009

(54) Container-forming assembly

(75) Inventors: Michael J. Smith, Sammamish, WA (US); Arden L. Kunkel, Tacoma, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/966,864

(22) Filed: Dec. 28, 2007

(51) Int. Cl. B31B 1/00

(52) U.S. Cl. 493/51

(57) ABSTRACT

A container-forming assembly for forming a container from a container blank generally includes an active mandrel configured for movement from a first position to a second position, and a forming chamber cooperatively configured to receive the active mandrel when the active mandrel is moving toward the second position.

### BACKGROUND

Containers made from cellulose-based substrates are used widely in many industries. For example, cellulose-based containers are used to ship products that are moist or packed in ice such as fresh produce or fresh seafood. When such containers take up moisture, they lose strength. To minimize or avoid this loss of strength, moisture-resistant, cellulose-based shipping containers have been developed, including containers formed from cellulose-based substrates that, for example, may include integrated moisture-resistant barriers or may be encapsulated in moisture-resistant films, as described in U.S. patent application Ser. Nos. 11/172,202, filed on Jun. 29, 2005; 10/879,846, filed on Jun. 29, 2004; and 11/650,601, filed on Jan. 5, 2007, the disclosures of which are hereby expressly incorporated by reference.

Cellulose-based containers including an integrated moisture-resistant barrier or encapsulated in a moisture-resistant film are preferably formed having gussets that are free of any seams between the bottom of the container and the top of the container to prevent leakage at the gussets. In addition, such containers are preferably formed using adhesive at the gusset folds to secure the container. Oftentimes, however, these containers are improperly formed using staples to secure the gussets, which puncture the polymeric film and render the container unusable if water wicks through the puncture holes. Moreover, such containers, when formed, take up significant space, particularly if used in environments with limited space, for example, when used on fishing vessels to package fresh seafood or on produce harvesting trucks to harvest and package fresh produce. Therefore, there exists a need for a container-forming assembly for quickly and easily forming containers from container blanks on site using proper container-forming procedures (e.g., using adhesive at the gussets, not staples).

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a container-forming assembly for forming a container from a container blank is provided. The assembly generally includes an active mandrel configured for movement from a first position to a second position and a forming chamber cooperatively configured to receive the active mandrel when the active mandrel is moving toward the second position.

In accordance with another embodiment of the present disclosure, in a container-forming assembly for forming a container from a container blank, an active mandrel is provided. The active mandrel generally includes a center press and first and second side arms attached to the center press, wherein the first and second side arms are configured for movement relative to the center press as the active mandrel moves from the first position to the second position.

In accordance with another embodiment of the present disclosure, a method of forming a container from a container blank is provided. The method generally includes placing a container blank between an active mandrel and a forming chamber cooperatively configured to releasably receive the active mandrel, and moving the active mandrel from a first position to at least a second position, such that when in the second position the mandrel is cooperatively received by a forming chamber.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a perspective view of a container-forming assembly in accordance with one embodiment of the present disclosure;

FIG. 2 is a side view of the assembly of FIG. 1;

FIG. 3A-3C are a series of perspective views of a container blank in the process of being formed into a container, as formed by the assembly of FIG. 1;

FIG. 4A is a perspective, close-up view of a mandrel of the assembly of FIG. 1, wherein the mandrel is oriented a first position;

FIG. 4B is a perspective, close-up view of the mandrel of FIG. 4A, wherein the mandrel is moving from a first position to a second position;

FIG. 4C is a perspective, close-up view of the mandrel of FIG. 4A, wherein the mandrel is oriented in the second position;

FIG. 4D is a perspective, close-up view of the mandrel of FIG. 4A, wherein the mandrel is oriented in a third position;

FIG. 4E is a perspective, close-up view of the mandrel of FIG. 4A in the third position and showing a container formed by the mandrel;

FIG. 5A is a perspective, close-up view of a mandrel and a forming chamber of the assembly of FIG. 1, wherein the mandrel is in a first position;

FIG. 5B is a perspective, close-up view of the mandrel and the forming chamber, wherein the mandrel is in a first position, as seen in FIG. 5A, and further including a container blank received within the assembly for being formed into a container;

FIG. 5C is a perspective, close-up view of the mandrel and the forming chamber, wherein the mandrel is transitioning between the first position, as seen in FIG. 5B, and the second position;

FIG. 5D is a perspective, close-up view of the mandrel and the forming chamber transitioning, wherein the mandrel is in the second position;

FIG. 5E is a perspective, close-up view of the mandrel and the forming chamber transitioning, wherein the mandrel is in the third position;

FIG. 6 is a top plan view of the mandrel in the first position, as seen in perspective view in FIG. 4A;

FIG. 7A is a top plan view of the of the forming chamber in the assembly of FIG. 1 in a first adjusted orientation; and

FIG. 7B is a top plan view of the of the forming chamber in the assembly of FIG. 1 in a second adjusted orientation.

### DETAILED DESCRIPTION

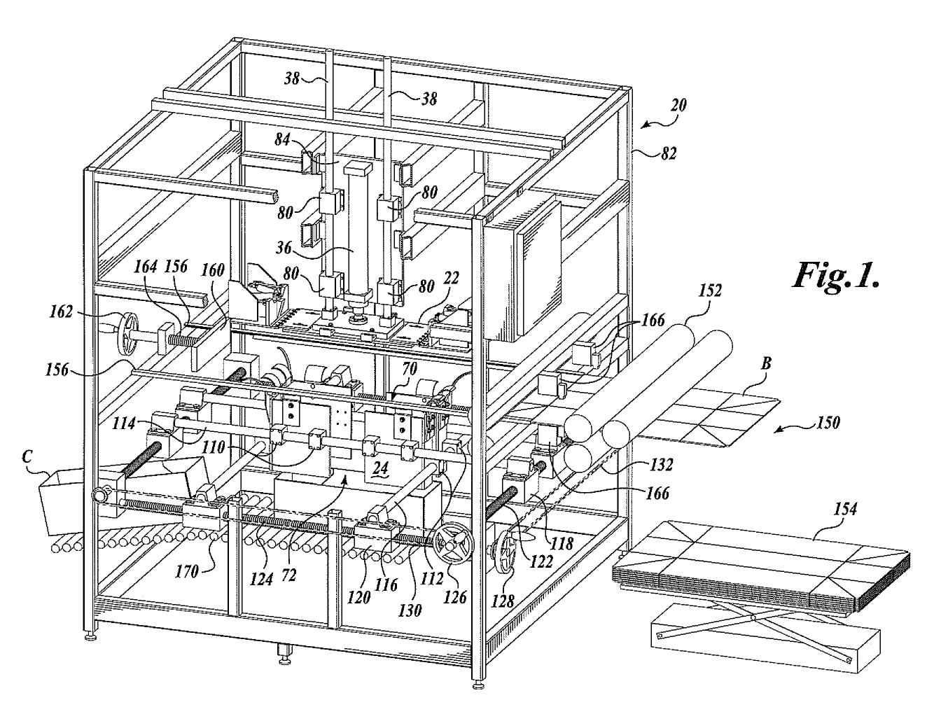

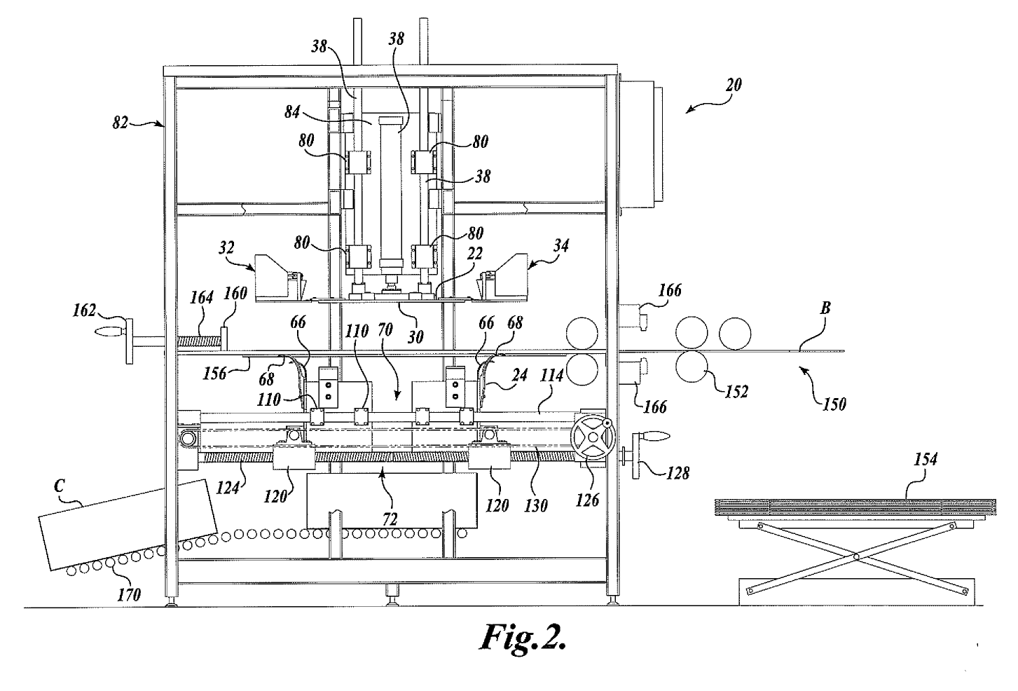

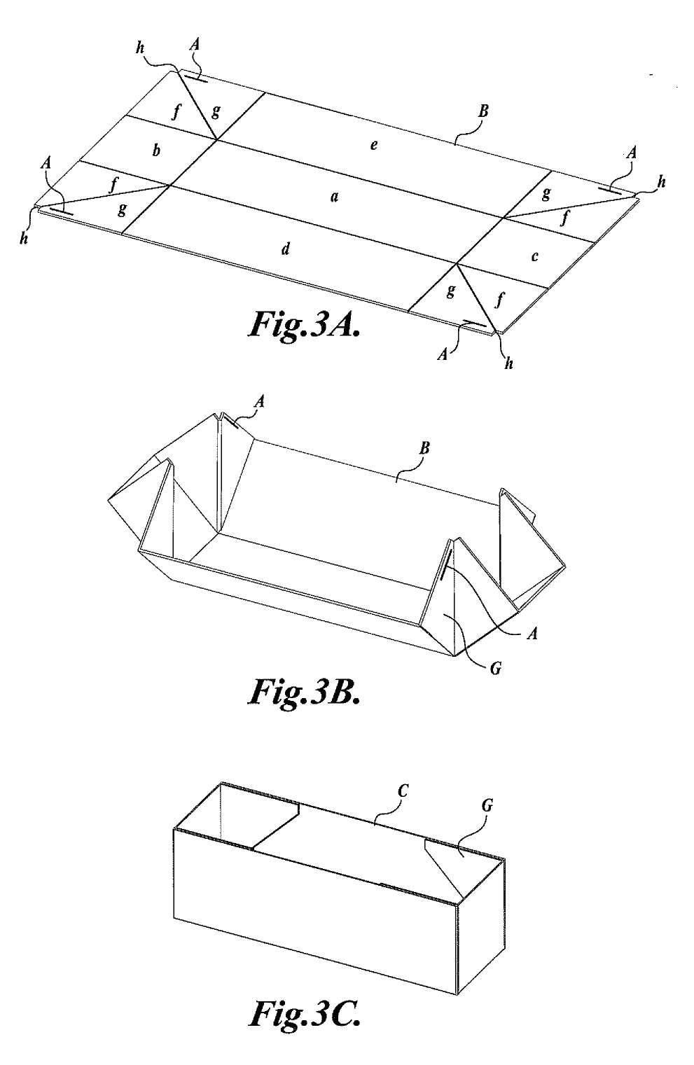

Embodiments of the present disclosure are generally directed to container-forming assemblies. Referring to FIGS. 1 and 2, there is shown a container-forming assembly generally indicated 20, constructed in accordance with the one embodiment of the present disclosure. The assembly 20 generally includes a mandrel 22 and a forming chamber 24 cooperatively configured and arranged to receive a container blank B and to press or form the blank B into a container C (see FIGS. 3A-3C). Embodiments of the assembly 20 are suitably used for on-site forming of containers C from blanks B, which results in proper container formation and significant on-site space savings.

It should be appreciated that in accordance with embodiments described herein, the blanks B and containers C may be moisture-resistant containers, e.g., formed from cellulose-based substrates that may include an integrated moisture-resistant barrier or may be encapsulated in moisture-resistant films, as described in U.S. patent application Ser. Nos. 11/172,202, filed on Jun. 29, 2005, 10/879,846, filed on Jun. 29, 2004, and 11/650,601, filed on Jan. 5, 2007, the disclosures of which are hereby expressly incorporated by reference. It should be appreciated, however, that blanks B and containers C formed from other materials, for example, noncellulose-based substrates, are also within the scope of the present disclosure.

It should further be appreciated that the terms “top”, “bottom”, “upper”, “upward”, “upwardly”, “inward”₇ and “inwardly”, and other directional terms used herein to describe the movement of the illustrated embodiment of the assembly 20 are used for illustrative purposes only, based on the orientation of the assembly 20 in the illustrated embodiment, and are not intended to be limiting. It should therefore be appreciated that assemblies designed in accordance with the scope of the present disclosure may be configured in other suitable orientations.

As best seen in FIGS. 3A-3C, a suitable container C formed by blank B generally includes a center panel (a) that forms the bottom surface of the container C, two end panels (b and c) and two side panels (d and e) that form, respectively, the ends and sides of the container C, and four pairs of substantially triangular-shaped gusset panels (f and g) that fold to form the four gussets G of the container C, all of which are separated by creases defined in the blank B, as described in greater detail in U.S. patent application Ser. No. 11/172,202, filed on Jun. 29, 2005, the disclosure of which is hereby expressly incorporated by reference. Notches (h) at each of the four corners of the blank B provide for improved folding and bonding of the blank B. In addition, creases between panels also provide for improved folding and bonding of the blank B.

The blank B further includes adhesive A, shown in a pattern in FIG. 3A on one side of the blank B, to secure the blank B in the form of a container C. As described in greater detail below, the adhesive A can be applied in a substantially similar pattern on both sides of the blank B for suitable container-forming. When folded, the resulting container C is an open, five-sided structure. As described in U.S. patent application Ser. No. 11/172,202, two containers C, for example, a bottom and a substantially similar top, can be telescopically joined to form an enclosing container assembly.

As a result of this design, the gussets G of the container C are substantially full-height gussets, meaning that they extend from the top of the container to the bottom of the container and are free of seams along the sides of the container to prevent leakage at the gussets. With such a design, the container C may be tipped up to approximately 45° from a level orientation and still operate as a moisture-resistant container because no moisture can leak through the sides of the container C along the moisture-resistant gussets G. In that regard, the assembly 20 described herein is designed to form a container C having suitable gussets G for a moisture-resistant container. As mentioned above, the container C is preferably formed using adhesive (rather than staples) to secure the gussets G in the folded orientation and to further maintain the moisture resistance of the container C.

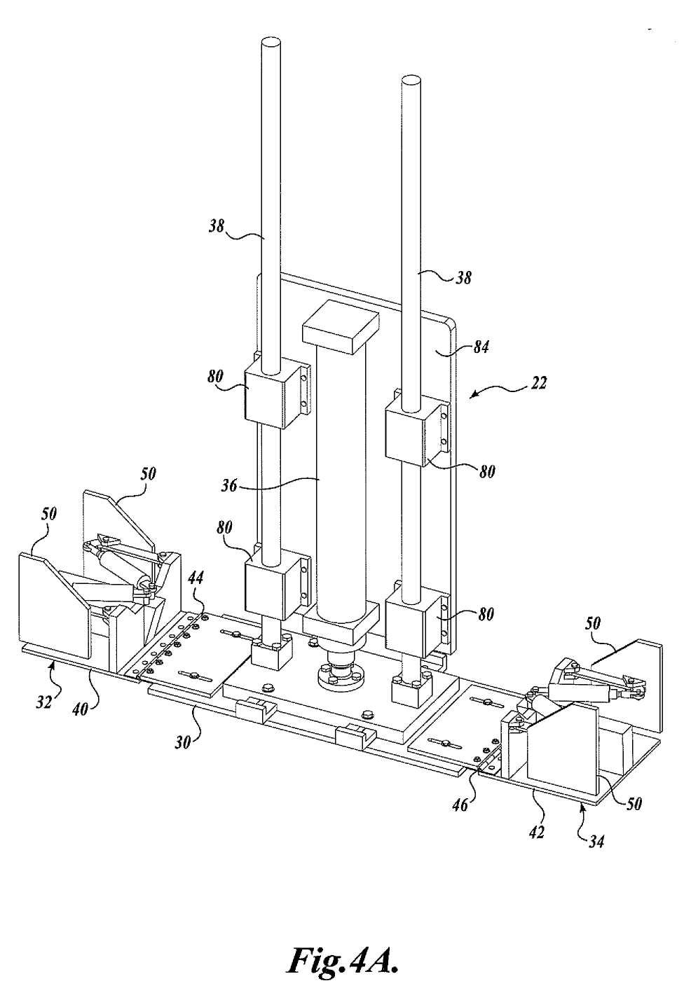

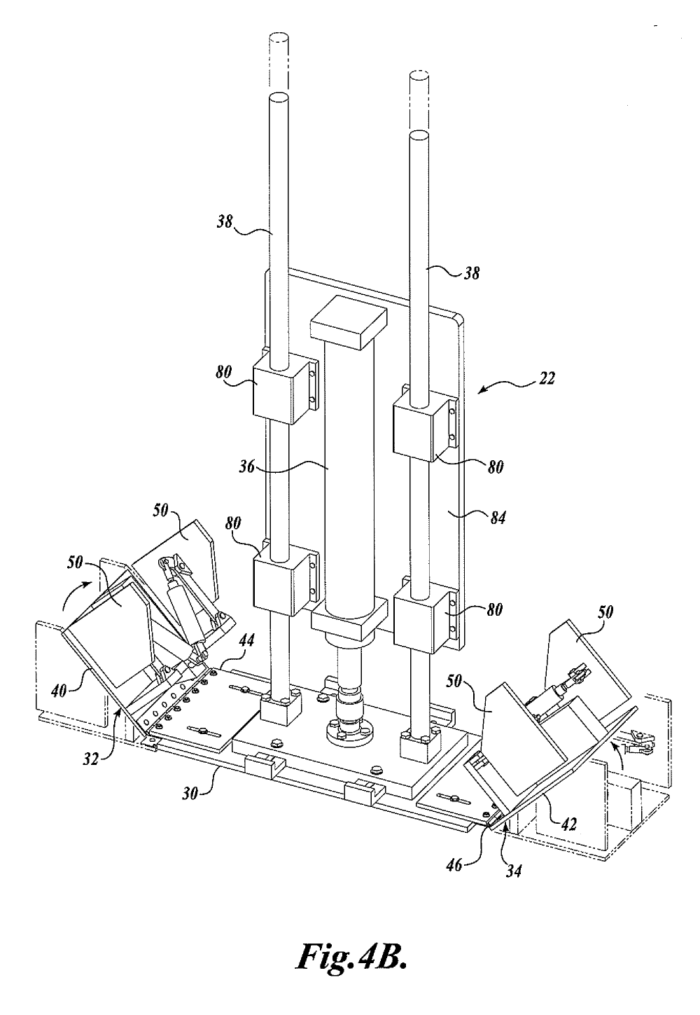

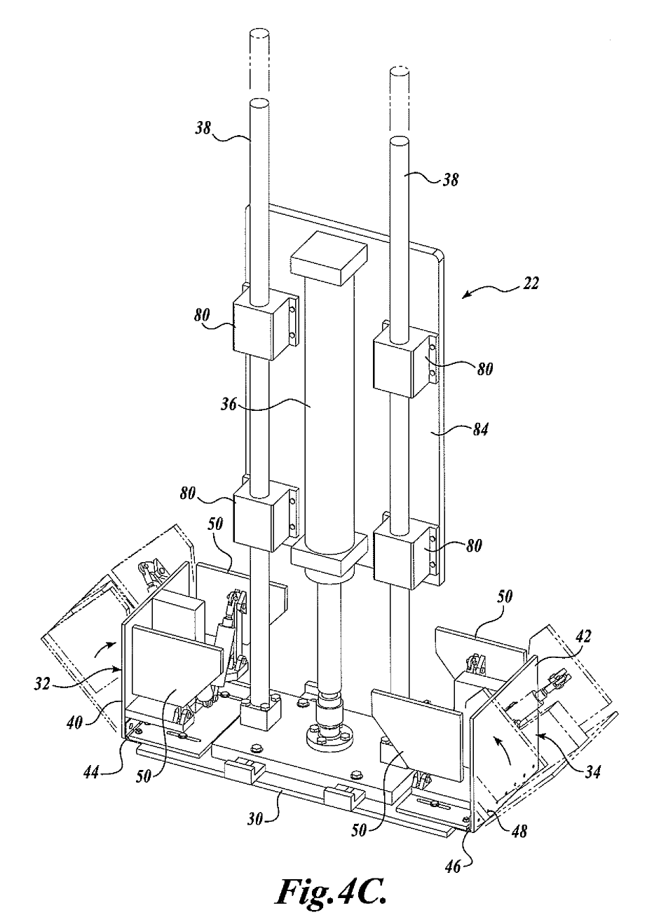

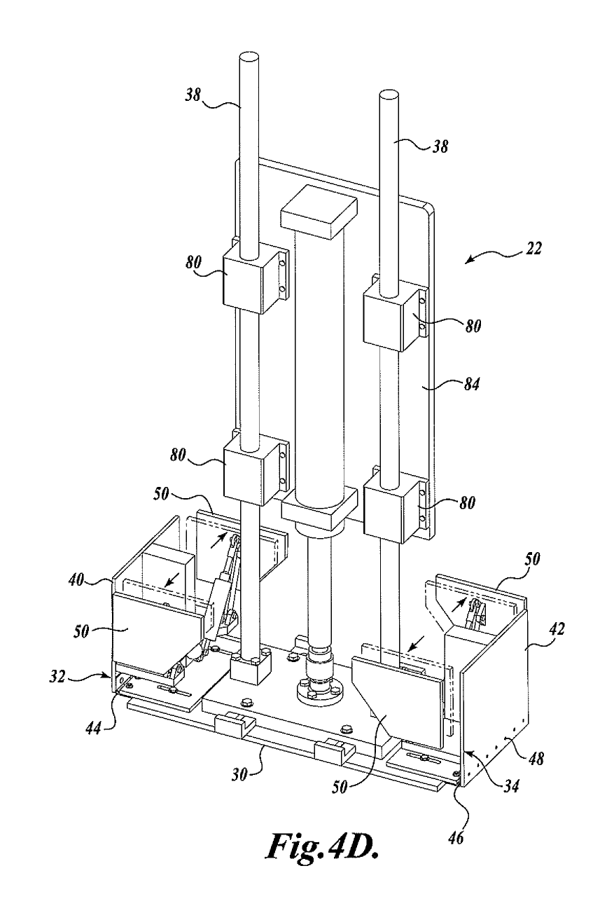

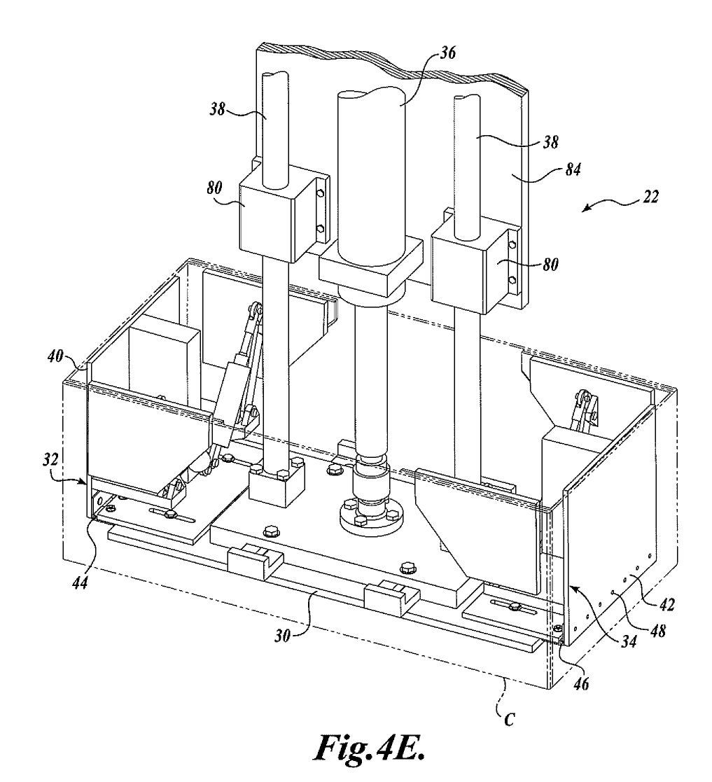

The assembly 20 will now be described in greater detail. Referring to FIGS. 4A-4D, the mandrel 22 of the assembly 20 is an active mandrel. In that regard, the mandrel 22 includes a center press 30 and first and second side arms 32 and 34 moveably attached to the ends of the center press 30. In the illustrated embodiment, the center press 30 is a rectangular press plate sized and configured to correspond with the interior dimensions of the rectangular center panel (a) of the blank B such that it can be used to press the blank B into a container C (see FIG. 4E). The rectangular center panel (a) of the blank B therefore becomes the bottom panel of the container C to be formed (see FIGS. 3A-3C). Referring now to FIG. 4E, it can be seen that the center press 30 fits within the dimensions of a formed container C.

It should be appreciated, however, that the center press 30 need not be a press plate, but may be a press frame or any other suitable pressing device having sufficient surface area to press the blank B into a container C. It should further be appreciated that the center press 30 need not be rectangular in shape, but may vary in shape depending on the desired container shape. The first and second side arms 32 and 34 of the mandrel 22 will be described in greater detail below.

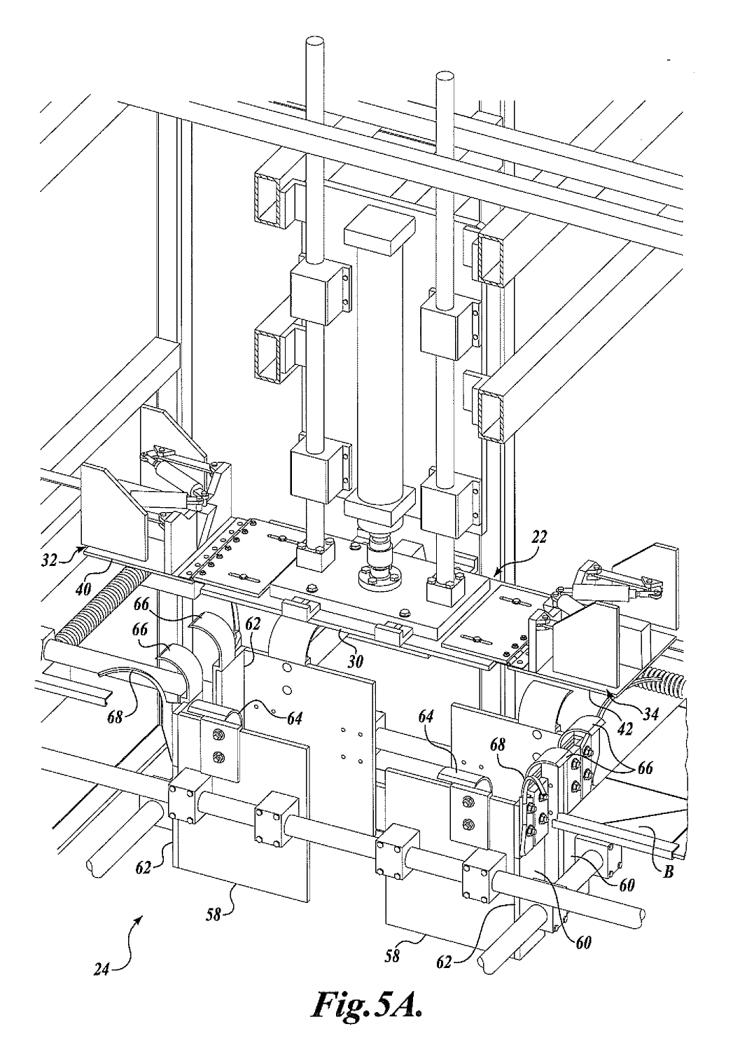

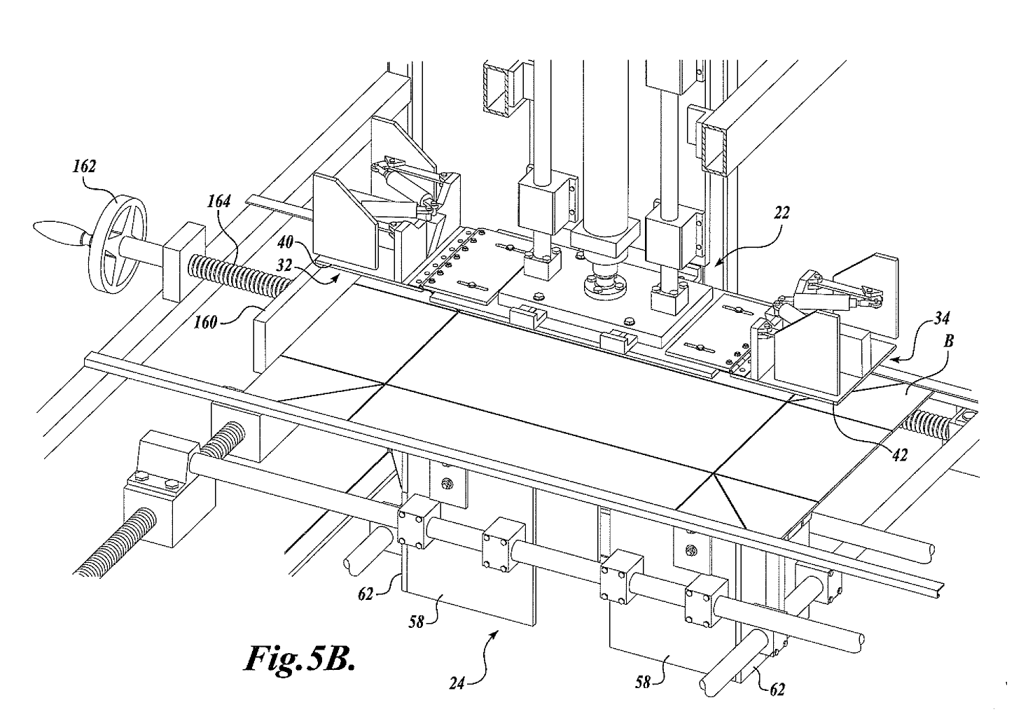

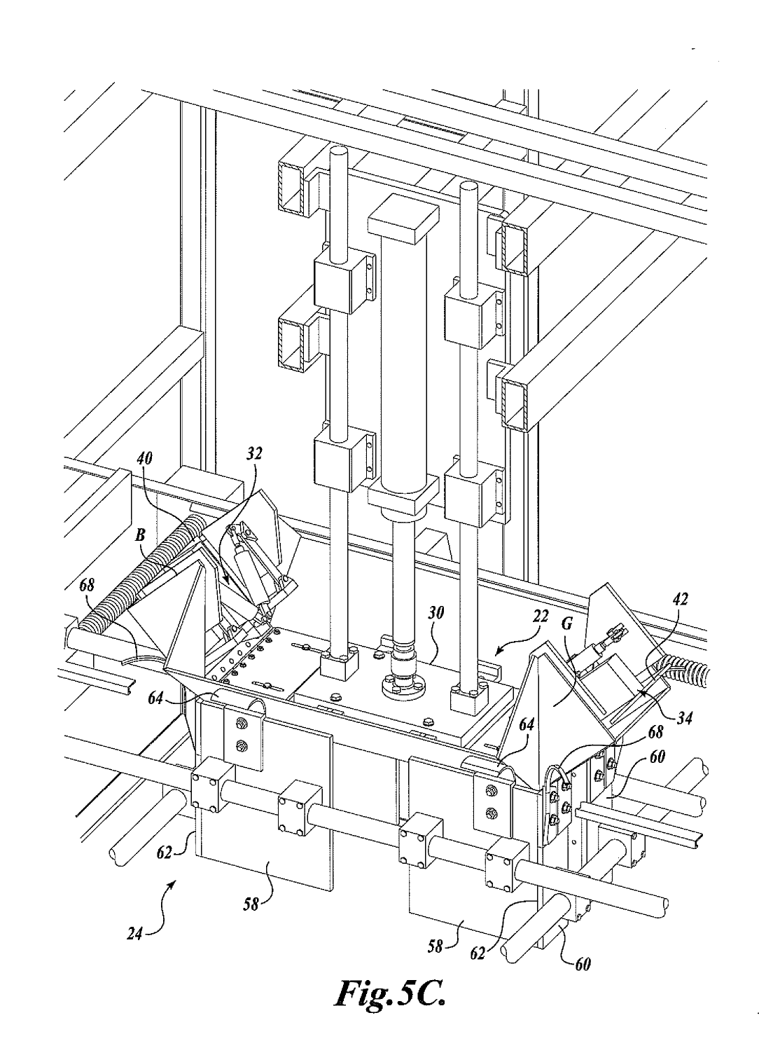

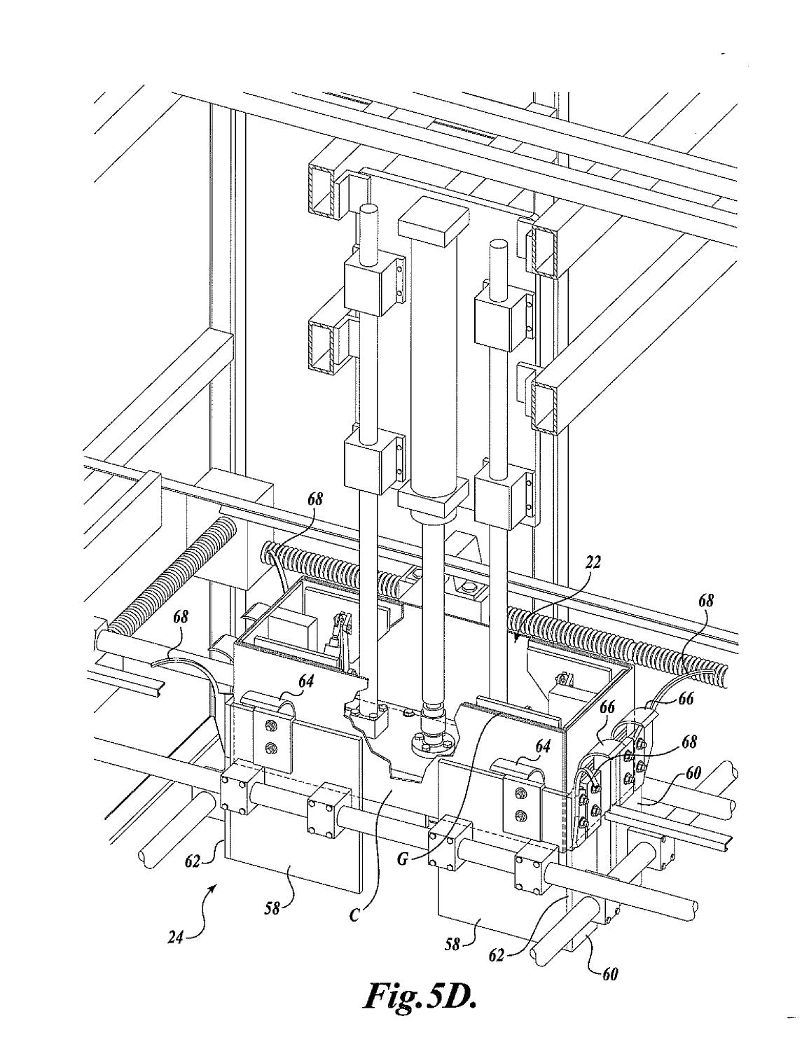

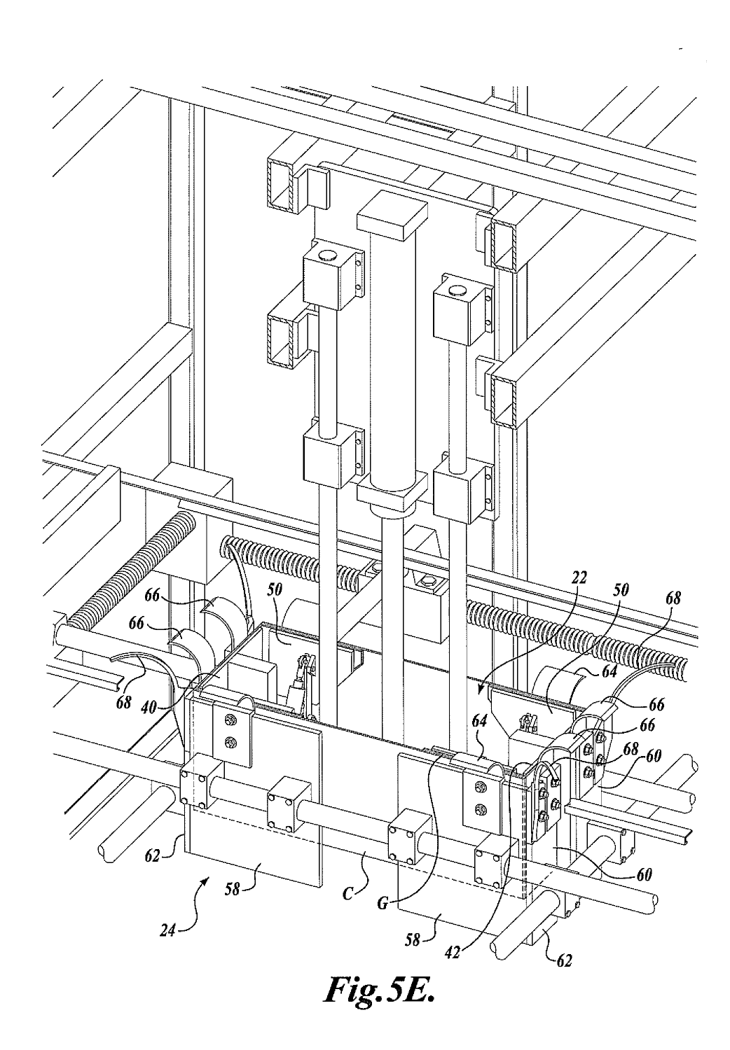

Still referring to FIGS. 4A-4D, the mandrel 22 further includes a reciprocating device 36 for moving the mandrel 22 between first and second positions relative to the forming chamber 24. As best seen in FIG. 4A, the first position is a receiving position, in which the assembly 20 is configured to receive a blank B (see also FIGS. 5A and 5B). As best seen in FIG. 4C, the second position is a forming position (see also FIG. 5D), in which the assembly 20 is configured to form a container C. In that regard, the mandrel 22 moves translationally along an axis extending substantially perpendicular to the longitudinal axis of the center press 30, to reciprocate the mandrel 22 between a position exterior to the forming chamber 24 (see FIGS. 5A and 5B) and a position interior to the forming chamber 24 (see FIGS. 5C and 5D). The mandrel 22 can therefore be used to press a blank B into a container C in the space between the mandrel 22 and the forming chamber 24.

In the illustrated embodiment, the reciprocating device 36 is coupled to the center press 30 of the mandrel 22 and is oriented substantially perpendicular to the longitudinal axis of the center press 30. It should be appreciated that the reciprocating device 36 for the mandrel 22 may activated by any suitable reciprocating means, such as a solenoid which actuates a pneumatic or hydraulic valve. It should further be appreciated that the mandrel 22 may include stabilizers 38 to maintain substantially parallel movement of the center press 30 of the mandrel 22 when reciprocated between the first and second positions. As a non-limiting example, the stabilizers 38 are shown in FIGS. 1 and 2 as rods extending parallel to the reciprocating device 36 and also attaching to the center press 30 of the mandrel 22. In the illustrated embodiment, the stabilizers 38 are received by slide bearings 80, which are rigidly attached to the frame 82 of the assembly 20 at plate 84 for additional stabilization. Therefore, the stabilizers 38 are configured for translational movement through the slide bearings 80.

As mentioned above, the mandrel 22 is an active mandrel. Therefore, in addition to translational movement, the mandrel 22 itself is capable of transforming as the mandrel 22 moves between the first position (see FIG. 4A) and the second position (see FIG. 4C). In addition, the mandrel 22 may be configured to move to a third position (see FIG. 4D), as described in greater detail below. As best seen in FIG. 5C, when moving between the first position and the second position, the first and second side arms 32 and 34 are configured to apply pressure to the end panels (b and c) of the blank B to aid in forming gussets G interior and to the sides of the container C. In that regard, as seen in FIG. 4A, the first and second side arms 32 and 34 include respective first and second side presses 40 and 42 that are hingedly attached to the center press 30 by first and second hinges 44 and 46 for rotational movement relative to the center press 30 as the mandrel 22 moves from the first position to the second position.

As a result of the hinged attachment, the first and second side presses 40 and 42 are configured to fold upwardly and inwardly (see FIGS. 4B and 4C) during the container-forming process, such that the dimensions of the mandrel 22 conform to the dimensions of the forming chamber 24 as the mandrel 22 enters the forming chamber 24. In that regard, the first and second side presses 40 and 42 rotate from an approximate 180° degree orientation relative to the center press 30 (see FIG. 4A) to an approximate 90° angle upward orientation relative to the center press 30 (see FIG. 4C) as the mandrel 22 moves from a first position exterior to the forming chamber 24 to the second position interior to the forming chamber 24 (see also FIGS. 5A and 5D).

While the side presses 40 and 42 are shown as rectangular press plates, it should be appreciated that, like the center press 30, the side presses 40 and 42 need not be press plates, but may be press frames or any other suitable pressing devices having sufficient surface area to press the blank B into a container C. Moreover, it should be appreciated that the side press plates 40 and 42 need not be rectangular in shape. Further, referring to FIGS. 4C-4E, it should be appreciated that fasteners 48 used to connect the hinges 44 and 46 are preferably countersunk fasteners on the exterior surfaces of the mandrel 22 that contact the blank B during the forming process, or other appropriate fasteners designed to minimize damage or interference with the blank B during the forming process (see FIG. 4E).

It should be appreciated that the hinged movement of the side arms 32 and 34 in the illustrated embodiment of the assembly 20 is passively controlled by gravitational force and contact with the forming chamber 24. In that regard, the side arms 32 and 34 are suitably weighted to provided sufficient pressure against the end panels (b and c) of the blank B to aid in forming gussets G interior to and adjacent the side panels (d and e) of the container C, as seen in FIGS. 5C and 5D. However, the side arms 32 and 34 are designed to hingedly rotate as the mandrel 22 moves from the first position to the second position and upon contacting the forming chamber 24, as described in greater detail below. It should further be appreciated that in other embodiments of the assembly 20, the movement of the side arms 32 and 34 may be actively controlled by any suitable control means, such as a solenoid which actuates a pneumatic or hydraulic valve.

Suitable weighting of the side arms 32 and 34 depends on several factors, including, but not limited to, the force applied by the reciprocating device 36 to move the mandrel 22 when pressing the blank B, as well as the stiffness, strength, and weight of the blank B. Moreover, the side aims 32 and 34 should be suitably weighted to fall back to the first position as the mandrel 22 is withdrawn from the forming chamber 24. In the alternative, the side arms 32 and 34 may include biasing means, such as a spring or solenoid-activated biasing mechanism to bias the side arms 32 and 34 back to the first position as the mandrel 22 is withdrawn from the forming chamber 24.

As mentioned above, the mandrel 22 may also be configured to transform to a third position, as best seen in FIGS. 4D and 5E. In that regard, when the mandrel 22 is received within the forming chamber 24, the first and second side arms 32 and 34 are configured to apply pressure outwardly against the folded gussets G of the container C toward the side walls (d and e) of the container C to ensure a proper gusset fold and/or to activate the gusset adhesive A. In the illustrated embodiment, the first and second side arms 32 and 34 include four gusset presses 50 configured to press along the four respective gussets G of the container C. As seen in FIGS. 4D and 5E, the gusset presses 50 are configured to be oriented substantially perpendicular to the first and second side presses 40 and 42 at the edges of the side presses 40 and 42. The gusset presses 50 are thus configured to press outwardly into the third position (see FIGS. 4D and 5E) and to press the gussets G against the sides of the container C. It should be appreciated that the gusset presses 50 may be activated by any suitable reciprocating means, such as a solenoid which actuates a pneumatic or hydraulic valve. As described in greater detail below, the gusset presses 50 are designed to maintain pressure against the gussets G of the container C for a suitable time period until the applied adhesive A holds.

Having described the mandrel 22, the forming chamber 24 will now be described in greater detail. Referring to FIGS. 5A-5E, the forming chamber 24 is configured to releasably receive the mandrel 22 when the mandrel 22 is moving from a first position to a second position. As the forming chamber 24 receives the mandrel 22, the mandrel 22 presses a blank B into a container C in the space between the mandrel 22 and the forming chamber 24.

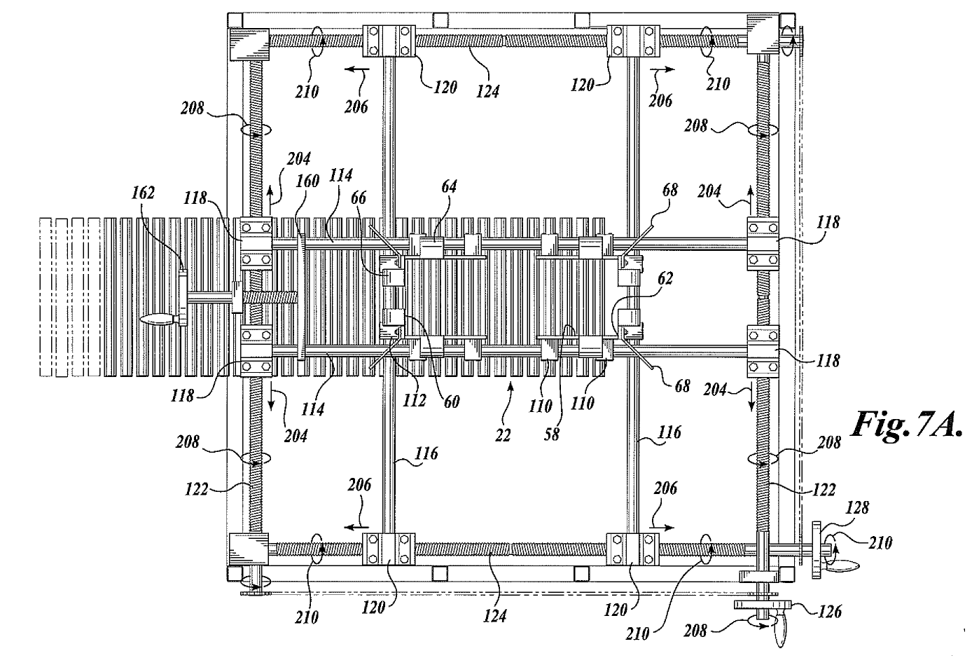

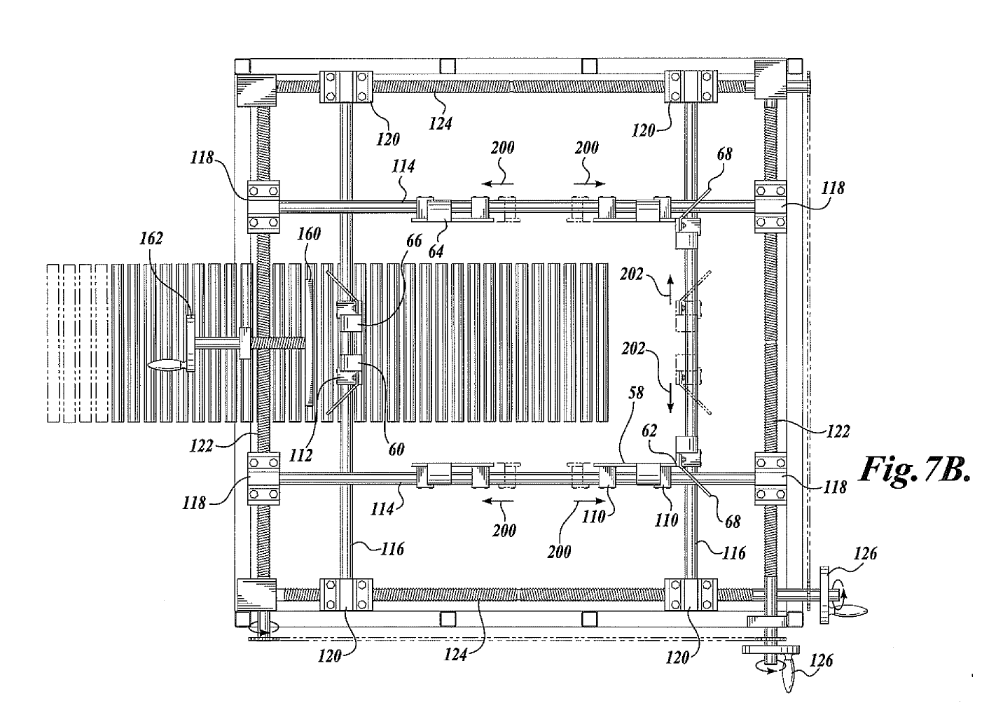

Referring to FIG. 5A, the forming chamber 24 includes a plurality of sidewalls 58 and end walls 60 configured for forming a container C from blank B. The side and end walls 58 and 60 are suitably oriented substantially perpendicular to the longitudinal axis of the center press 30 and, therefore, also substantially perpendicular to the orientation of the blank B when the assembly 20 is in the first position (see FIG. 5B). In the illustrated embodiment, the forming chamber 24 is rectangular in shape for forming a rectangular container C (see also a top view of the forming chamber 24 in FIG. 7A). Therefore, adjacent sidewalls 58 and end walls 60 in the forming chamber 24 meet to form four corners 62. It should be appreciated, however, that while the forming chamber 24 in the illustrated embodiment is rectangular in shape, other forming chamber shapes may also be within the scope of the present disclosure.

The forming chamber 24 further includes a plurality of sidewall and end wall guides 64 and 66 positioned, respectively, along the upper periphery of the sidewalls 58 and end walls 60 to help the blank B begin its folds when pressed by the mandrel 22 into the forming chamber 24. In the illustrated embodiment, the sidewall and end wall guides 64 and 66 extend outwardly and upwardly in an arcuate manner from the upper periphery of the sidewalls 58 and end walls 60 normal to the upper periphery of the sidewalls 58 and end walls 60. The sidewall and end wall guides 64 and 66 are thus configured to guide a blank B into the forming chamber 24 by initiating folding along the center rectangular panel creases, so as to prevent the blank B from getting caught on the upper peripheral edges of the sidewalls 58 and end walls 60 of the forming chamber 24 as the mandrel 22 presses on the center rectangular panel (a) of the blank B (which becomes the bottom surface of the container C, as seen in FIGS. 3A-3C). As best seen in FIG. 5C, the sidewall and end wall guides 64 and 66 help the blank B begin its folds along its center rectangular panel creases as it begins to fold from a blank B into a container C.

In addition to sidewall and end wall guides 64 and 66, the forming chamber 24 also includes corner guides 68, positioned at the respective corners 62 of the forming chamber 24 where adjacent sidewalls 58 and end walls 60 meet. The corner guides 68 are configured to assist in the folding of the gusset G as the blank B is pressed into the forming chamber 24. The corner guides 68, like the sidewall and end wall guides 64 and 66, also extend outwardly and upwardly in an arcuate manner from the upper periphery of the sidewalls 58 and end walls 60. However, unlike the sidewall and end wall guides 64 and 66, the corner guides 68 are slim finger guides that extend diagonally from the respective corners 62 of the forming chamber 24, making an approximate 135° angle with each of the adjacent sidewalls 58 and end walls 60 (see also a top view of the forming chamber 24 and the corner guides 68 in FIG. 7A). In that regard, the corner guides 68 must be slim guides to define a sharp crease in the blank B when initiating the folding of the crease of the gusset G between the substantially triangular-shaped panels (f and g) as the blank B is pressed into the forming chamber 24. In one embodiment, the corner guides 68 are less than ¼ inch in width.

Moreover, as best seen in FIG. 2, the corner guides 68 are configured to extend further outwardly and upwardly than the sidewall and end wall guides 64 and 66, such that during the container-forming process, the blank B comes into contact with corner guides 68 before contacting the sidewall and end wall guides 64 and 66. In this manner, the corner guides 68 act as finger guides that assist in initiating the folding of the crease of the gusset G between the substantially triangular-shaped panels (f and g) such that the gusset G folds toward the interior surfaces of the side panels (d and e) of the container C before the side and end panels of the blank B begin to enter the forming chamber 24.

As best seen in FIGS. 5C and 5D, the interaction of at least three different parts of the assembly 20 aid in the formation of the gussets G toward the interior side panel surfaces (d and c) of the container C: (1) pressure from the center press 30 on the center panel (a) and from the first and second side presses 40 and 42 on the end panels (b and c) of the blank B; (2) guiding from the rectangular shape of the first and second side presses 40 and 42 and/or the gusset presses 50 oriented substantially perpendicular to and at the edges of the first and second side presses 40 and 42 to maintain a substantially 90° angle between each adjacent substantially triangular-shaped panel (f) of the gusset G and the end panels (b and c) of the blank B; and (3) inward finger guiding from the corner guides 68 to assist in initiating the folding of the crease of the gusset G toward the interior surfaces of the side panels (d and e) and to initiate folding along the creases around the center panel (a). In the illustrated embodiment, the corner guides 68 are attached to the end walls 60; however, it should be appreciated that the corner guides 68 may also be attached to the side walls 58.

It should further be appreciated that, while the gussets G are formed toward the interior side panel surfaces (d and e) of the container C in the illustrated embodiment, the gussets G may be formed toward other surfaces, for example, the interior end panel surfaces (b and c) in accordance with another embodiment of the present disclosure. In this embodiment, the first and second side presses of the mandrel may be configured to extend from the sides of the center press to press on the side panels (d and e) of the blank B.

As can be readily appreciated from the figures, the forming chamber 24 has an open inlet 70 for receiving the blank B and the mandrel 22 as the mandrel moves from the first position to the second position. In addition, the forming chamber 24 may have an open outlet 72 for releasing the formed container C, for example, onto a conveyor 170 (see FIGS. 1 and 2). As a non-limiting example of operation of the assembly 20, a container C in the forming chamber 24 may be pushed on the conveyor 170 as a new blank B is pressed into the forming chamber 24 by the mandrel 22.

Because the forming chamber 24 and the mandrel 22 are cooperatively configured and arranged to form a blank B into a container C, the forming chamber 24 is sized and configured to correspond to the dimensions of the mandrel 22. In that regard, the forming chamber 24 has length and width dimensions that substantially correspond with the dimensions of the center press 30 of the mandrel 22. It should be appreciated that, while the forming chamber 24 length and width dimensions cannot be smaller than the center press 30 dimensions, the forming chamber 24 dimensions need not be exactly sized to correspond to the center press 30 dimensions. In that regard, the forming chamber 24 dimensions may be larger than the dimensions of the center press 30 within reasonable tolerances suitable for container forming. As a non-limiting example, for a two-piece container assembly made from substantially similar top and bottom containers that are telescopically joined together, the assembly 20 may be configured to form differently sized top and bottom portions without changing the dimensions of the forming chamber 24 or the mandrel 22. In that regard, the blanks B for the container top and the container bottom may be designed such that the container top is slightly larger than the container bottom to facilitate assembly of the container top together with the container bottom.

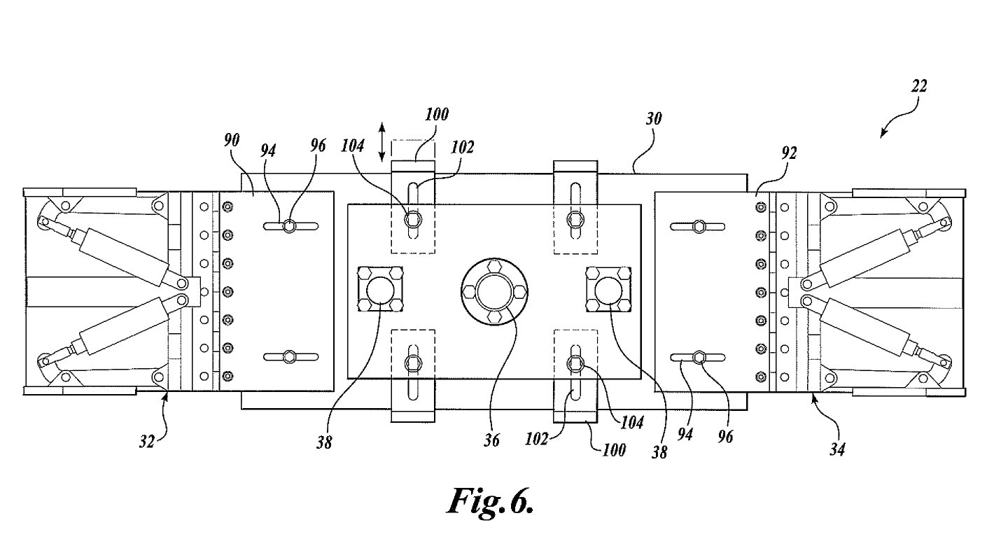

Referring now to FIGS. 6, 7A, and 7B, both the mandrel 22 and the forming chamber 24 may be configured to be adjustable to accommodate a variety of container sizes. In the illustrated embodiment, the mandrel 22 is shown as being adjustable in both the length and width of its center press 30 dimensions. In that regard, the first and second side arms 32 and 34 are adjustably attachable to the ends of the center press 30 to change the length of the center press 30 so as to press containers that are longer in length. Referring to the top view of the mandrel 22 in FIG. 6, the first and second side arms 32 and 34 each include respective mounting plates 90 and 92 for mounting to the center press 30 by adjustable attachment means. As seen in the illustrated embodiment, the mounting plates 90 and 92 include elongated slots 94 for receiving fasteners 96 that extend through holes (not shown) in the center press 30. In that regard, the mounting plates 90 and 92 may be adjusted to achieve a suitable center press 30 length by loosening the fasteners 96 and readjusting the positioning of the fasteners 96 within the elongated slots 94 of the mounting plates 90 and 92.

In addition, the width of the center press 30 is also adjustable, for example, by adjusting width extensions 100 attached to the center press 30 by adjustable attachment means. As seen in the illustrated embodiment, similar to the adjustable mounting plates 90 and 92 of the side arms 32 and 34, the width extensions 100 also include elongated slots 102 for receiving fasteners 104 that extend through holes (not shown) in the center press 30. In that regard, the width extensions 100 may be adjusted by loosening the fasteners 104 and adjusting the positioning of the fasteners 104 within the elongated slots 102 to achieve a suitable center press 30 width. While the width extensions 100 are shown as four discrete adjustable extensions, it should be appreciated that the width extensions may be configured as two discrete adjustable extensions (one on each side of the center press 30), for example, as plates or bars having slotted attachment means. It should also be appreciated that fasteners 96 and 104 are preferably designed not to extend through the pressing surface of the center press 30, so as to minimize any damage by the center press 30 to the blank B or container C during the container-forming process.

Referring now to FIGS. 7A and 7B, the forming chamber 24 is also configured as an adjustable chamber, such that the length and width dimensions may be adjusted to correspond with different center press 30 dimensions for different container C sizes. In accordance with one suitable embodiment, a configuration for adjusting the dimensions of the forming chamber 24 will now be described. As discussed above, the forming chamber 24 is made up of a plurality of sidewalks 58 and end walls 60. Side and end slide bearings 110 and 112 are coupled to and support the sidewalls 58 and end walls 60, respectively, to maintain the walls in their preferred orientation (see also FIGS. 1 and 2), which is substantially perpendicular to the longitudinal axis of the center press 30. The slide bearings 110 and 112 are moveable along respective side and end support bars 114 and 116 (see respective arrows 200 and 202 in FIG. 7B). The movement of the slide bearings 110 and 112 along the side and end support bars 114 and 116 causes movement of the respective sidewalls 58 and end walls 60. In that regard, the slide bearings 110 and 112 are suitably positioned along the side and end support bars 114 and 116 such that adjacent sidewalls 58 and end walls 60 meet to form four corners 62.

As best seen in FIG. 7A, the side and end support bars 114 and 116 are adjustable from a first adjusted orientation (see respective arrows 204 and 206), to redefine the dimensions of the forming chamber 24 to one or more other adjusted orientations (see, for example, FIG. 7B). In that regard, the side and end support bars 114 and 116 are attached to respective block bearings 118 and 120 fixed along respective threaded shafts 122 and 124. As described in greater detail below, cranks 126 and 128 enable an operator to rotate the threaded shafts (see respective arrows 208 and 210) to move the respective block bearings 118 and 120 along the respective threaded shafts 122 and 124, which, in turn, adjusts the positioning of the side and end support bars 114 and 116.

As seen in the illustrated embodiment of FIGS. 1 and 2, belt devices 130 and 132 can be configured, for example, to move opposing threaded shafts 122 at the same time by using only one crank 126. Accordingly, the shafts 122 and 124 are suitably threaded so as to have opposite threads on opposite end of the shafts 122 and 124. In that manner, as best seen in FIG. 7A, as the cranks 126 and 128 are turned in either clockwise or counter-clockwise directions, the block bearings 118 and 120 move either toward one another or away from one another. When adjusted to move toward one another, the side and end support bars 114 and 116 are configured for smaller container C dimensions. When adjusted to move away from one another, the side and end support bars 114 and 116 are configured for larger container C dimensions. Although illustrated as manual cranks 126 and 128, it should be appreciated that the dimensions of the forming chamber 24 may be adjusted automatically by an assembly control system.

Now returning to FIGS. 1 and 2, the assembly 20 may further include a blank feed portion 150. The blank feed portion 150 of the assembly 20 includes feed rollers 152 and feed stack 154 for feeding blanks into the assembly 20. The blank feed portion 150 further includes a receiving device 156 shown as parallel rails for slidably guiding the blanks into proper positioning between the mandrel 22 and the forming chamber 24. The receiving device 156 may be adjustable to accommodate varying blank B widths. It should be appreciated, however, that in lieu of a receiving device 156, the blank B may merely be placed by an operator to rest on the top of the corner guides 68 of the forming chamber 24.

The assembly 20 may further include a blank stop 160 at the end of the receiving device 156 (see also FIG. 5B). When the blank B hits the stop 160, the operator can initiate the operation of the assembly 20 and the pressing of the blank B by the mandrel 22. Moreover, the stop 160 may be configured to trigger a limit switch (not shown) that automatically initiates the operation of the assembly 20 and the pressing of the blank B by the mandrel 22. As seen in the illustrated embodiment, the stop 160 may be adjustable to accommodate varying blank B lengths. Although illustrated as including a manual crank 162 to turn threaded shaft 164, it should be appreciated that the stop 160 may also be automatically adjustable by an assembly control system.

The blank feed portion 150 may further include adhesive applicators 166, shown as adhesive guns, for applying adhesive A to the blank B for proper container forming. The adhesive applicators 166 are suitably positioned above and below the blank feed to apply adhesive A to both sides of the blank B in the pattern shown in FIG. 3A on both sides of the blank B. The adhesive pattern on a blank B shown in FIG. 3A will suitably adhere the folded gusset G to the interior side panel of the container C. However, it should be appreciated that other adhesive application patterns are also within the scope of the present disclosure. It should further be appreciated that the adhesive A may be a combination of a fast holding hot melt adhesive and a longer holding, water resistant adhesive, such as a polyvinyl acetate (PVA) or other suitable adhesive. By combining a fast holding adhesive with a longer holding adhesive, blanks B can be processed more quickly through the assembly 20 without compromising adhesive quality and longevity.

As described above, the assembly 20 may further include a conveyor 170 to convey the finished containers C as they exit the forming chamber 24. In the illustrated embodiment, the conveyor 170 is sloped with a suitable grade, such that gravitational pull will transport the finished containers C away from the outlet 72 of the forming chamber 24.

The operation of the assembly 20 will now be described with reference to FIGS. 1, 2, and 5A-5E. Referring to FIGS. 1 and 2, the blank B feeding process into the assembly will first be described. A blank B may be received within the feed portion 150 of the assembly 20 from the feed stack 154. In that regard, the blank B is fed into feed rollers 152, past adhesive applicators 166 where adhesive is applied in the pattern shown in FIG. 3A, and along receiving device 156. As the blank B is fed onto the receiving device 156, it will be stopped by adjustable feed stop 160. It should be appreciated that the feed stop 160 and the receiving device 156 will be configured either automatically or by an operator to accommodate the length and width dimensions of the blank B. In that regard, when fed a blank B, the assembly 20 will be suitably configured to receive the blank B such that it is properly oriented between the mandrel 22 and the forming chamber 24 to be formed into a container C. When the blank B has been received and properly oriented between the mandrel 22 and the forming chamber 24, the assembly 20 can begin the forming process, either automatically by a limit switch (not shown) on the feed stop 160 or by operator instruction.

The forming process will now be described with reference to FIGS. 5A-5E. As described above, the mandrel 22 is configured to move between a first position (see FIG. 5B) and a second position (see FIG. 5D) to form the blank B into a container C. Referring to FIG. 5C, as the mandrel 22 moves from the first position to the second position, the center press 30 presses against the rectangular center panel (a) of the blank B, and the first and second side presses 40 and 42 of the respective first and second side arms 34 and 36 apply pressure to the end panels (b and c) of the blank B. In addition, corner guides 68 of the forming chamber 24 assist in forming a sharp crease between adjacent substantially triangular-shaped panels (f and g) at the gussets G to begin folding the gussets G and to begin folding along the creases around the center panel (a) as the blank B is pressed into the forming chamber 24. Further, guiding from the rectangular shape of the first and second side presses 40 and 42 and/or the gusset presses 50 oriented substantially perpendicular to and at the edges of the first and second side presses 40 and 42 maintain an approximate 90° angle between each of the adjacent substantially triangular-shaped panels (f) of the gusset G and the end panels (b and c) of the blank B as the gussets G are formed toward the interior side panel surfaces (d and e) of the container C. In this manner, the gussets G are formed to the interior surfaces of the sides of the container C.

As the center press 30 of the mandrel 22 continues to press against the rectangular center panel (a) of the blank B, sidewall and end wall guides 64 and 66 guide the blank B into the forming chamber 24 along the creases around the center panel (a), as seen in FIGS. 5C and 5D, until the blank B and the mandrel 22 are fully received within the forming container 24 in the second position. After the mandrel 22 reaches the second position, the gusset presses 50 of the mandrel 22 move to the third position to press against the gussets G outwardly against the interior side panel surfaces (d and e) of the container C (see FIG. 5E). The pressing action of the gusset presses 50 ensures a proper gusset fold and/or activates gusset adhesives A.

After the gussets G have been pressed, the gusset presses 50 are withdrawn from the third position to the second position, and then the mandrel 22 is withdrawn from the second position (interior to the forming chamber 24) to the first position (exterior to the forming chamber 24). When the mandrel 22 reaches the first position, the assembly 20 is ready to receive a new blank B. In that regard, as the new blank B is pressed into the forming chamber 24 by the mandrel 22, the new blank B presses against the first blank B until the first blank B is released from the open outlet 72 of the forming chamber 24 onto conveyor 170 that carries first blank B away from the assembly 20.

As described above, the mandrel 22 and the forming chamber 24 are adjustable to accommodate a variety of container sizes. In that regard, in between forming operations, an assembly operator can adjust the length and the width of both the mandrel 22 and the forming chamber 24 by manual or automatic adjustment mechanisms described in detail above.

While illustrative embodiments have been illustrated and described, it will be appreciated that various changes can be made therein without departing from the spirit and scope of the disclosure.

The embodiments of the disclosure in which an exclusive property or privilege is claimed are defined as follows.:

1. A container-forming assembly for forming a container from a container blank, comprising:
(a) an active mandrel configured for movement from a first position to a second position; and
(b) a forming chamber cooperatively configured to receive the active mandrel when the active mandrel is moving toward the second position.

2. The assembly of claim 1, wherein the active mandrel is configured for translational movement from the first position to the second position.

3. The assembly of claim 1, wherein the active mandrel is exterior to the forming chamber when in the first position.

4. The assembly of claim 1, wherein the active mandrel is interior to the forming chamber when in the second position.

5. The assembly of claim 1, wherein the active mandrel includes a center press and first and second side arms moveably attached to the center press.

6. The assembly of claim 5, wherein the first and second side arms are hingedly attached to the center press.

7. The assembly of claim 5, wherein the first and second side arms are configured for rotational movement relative to the center press as the active mandrel moves from the first position to the second position.

8. The assembly of claim 1, wherein the center press is adjustable in at least one of a length and a width dimension to accommodate container blanks of varying sizes.

9. The assembly of claim 1, wherein the forming chamber is adjustable in at least one of a length and a width dimension to receive container blanks of varying sizes.

10. The assembly of claim 1, wherein the active mandrel is further configured for movement from the second position to a third position.

11. The assembly of claim 10, wherein the active mandrel includes a plurality of gusset presses configured to press along the respective gussets of the container when the active mandrel is in the third position.

12. In a container-forming assembly for forming a container from a container blank, an active mandrel, the active mandrel comprising:
(a) a center press; and
(b) first and second side arms attached to the center press, wherein the first and second side arms are configured for movement relative to the center press as the active mandrel moves from the first position to the second position.

13. The active mandrel of claim 12, wherein the first and second side aims are hingedly attached to the center press for rotational movement relative to the center press.

14. The active mandrel of claim 12, wherein the center press is adjustable in at least one of a length and a width dimension to press container blanks of varying sizes.

15. The active mandrel of claim 12, further comprising a plurality of gusset presses configured for movement from the second position to a third position, such that the plurality of gusset presses press against respective gussets of the container.

16. A method of forming a container from a container blank, comprising:
(a) placing a container blank between an active mandrel and a forming chamber cooperatively configured to releasably receive the active mandrel; and
(b) moving the active mandrel from a first position to at least a second position, such that when in the second position the mandrel is cooperatively received by a forming chamber.

17. The method of claim 16, wherein the active mandrel is exterior to the forming chamber when in the first position, and wherein the active mandrel is interior to the forming chamber when in the second position.

18. The method of claim 16, wherein the active mandrel includes a center press and first and second side arms, and wherein the first and second side arms move relative to the center press as the active mandrel moves from the first position to the second position.

19. The method of claim 16, wherein the method further includes moving the active mandrel from a second position to a third position, such that a plurality of gusset presses press against respective gussets of the container.

20. The method of claim 16, wherein the method further includes adjusting the active mandrel and the forming chamber in at least one of a length and a width dimension.
